(19) United States
(12) Patent Application Publication
(10) Pub. No.: US 2020/0239050 A1
(43) Pub. Date: Jul. 30, 2020

(54) SYSTEMS AND METHODS FOR TESTING AN INDUSTRIAL CART IN A GROW POD

(71) Applicant: Grow Solutions Tech LLC, Vineyard, UT (US)

(72) Inventors: Gary Bret Millar, Highland, UT (US); Michael Tyler Wirig, Pleasant Grove, UT (US); Mark Gerald Stott, Eagle Mountain, UT (US)

(73) Assignee: Grow Solutions Tech LLC, Vineyard, UT (US)

(21) Appl. No.: 16/264,094

(22) Filed: Jan. 31, 2019

Related U.S. Application Data
(63) Continuation of application No. PCT/US19/15853, filed on Jan. 30, 2019.

(51) Int. Cl. B61L 25/02; B61L 7/06; B60M 1/30; B60M 7/00; A01G 9/14

(52) U.S. Cl. CPC B61L 25/025; B61L 7/06; B60M 1/30; B60Y 2200/912; A01G 9/143; B60Y 2200/30; B60M 7/00

(57) ABSTRACT

A testing station for testing an industrial cart includes a controller, a length of track having a first section, a second section, and a third section. Sensors are communicatively coupled to the controller, where the sensors are configured to at least detect a cart traversing the third section. An electric source electrically coupled to the second section, where the second section provides electric power to a first pair of wheels of a cart when the cart traverses the first section and the second section, and the second section provides electric power to a second pair of wheels when the cart traverses the second section and the third section. An instruction set causes the processor to receive, from a first sensor, signals indicating the cart is traversing the third section and in response to receiving the signals indicating that the cart is traversing the third section, determine the cart is functioning.

### CROSS-REFERENCE TO RELATED APPLICATIONS

This application is a continuation of International Patent Application No. PCT/US19/15853, filed Jan. 30, 2019, the entire contents of which are incorporated herein by reference.

### TECHNICAL FIELD

Embodiments described herein generally relate to systems and methods for testing an industrial cart in a grow pod and, more specifically, to testing the functionality of industrial carts in an assembly line configuration of a grow pod.

### BACKGROUND

While crop growth technologies have advanced over the years, there are still many problems in the farming and crop industry today. As an example, while technological advances have increased efficiency and production of various crops, many factors may affect a harvest, such as weather, disease, infestation, and the like. Additionally, certain countries, regions and/or populations may not have suitable farmland to grow particular crops.

Currently, greenhouses and grow houses utilize stationary trays for growing plants. This typically requires large amounts of floor space because workers must be able to access the trays in order to water and otherwise tend to the plants while they are growing. For example, stationary trays in greenhouses need to be periodically rotated or relocated so the plants growing within them receive the required amount of light and/or exposure to environmental conditions such as humidity or airflow. Consequently, greenhouses must provide additional floor space for workers to carry out these tasks and may be limited by the vertical reach of the worker. Greenhouses and grow houses are only an example where a facility needs to accommodate access to stationary objects from time to time by a worker. Other environments, such as warehouses, fulfillment centers or the like must also utilize large amounts of floor space and may be vertically limited by the height of their workers.

As such, a need exists to improve environments such as greenhouses and grow houses, which can reduce the amount of direct worker interaction with stationary objects, such as a plant during the growing process and remove limitations on the use of large floor spaces and relatively small vertical elevations for growing plants.

### SUMMARY

In one embodiment, a testing station for testing an industrial cart includes a master controller having a processor and a non-transitory computer readable memory communicatively coupled to the processor, a length of track including a first section of track, a second section of track, and a third section of track. The first section of track mechanically couples to the second section of track, the second section of track mechanically couples to the third section of track, the first section of track is electrically isolated from the second section of track, and the second section of track is electrically isolated from the third section of track. The testing station further include one or more sensors communicatively coupled to the master controller, where the one or more sensors are configured to at least detect a cart traversing the third section of track, an electric power source electrically coupled to the second section of track, where the second section of track provides electric power to a first pair of wheels of a cart when the cart traverses the first section of track and the second section of track, and the second section of track provides electric power to a second pair of wheels when the cart traverses the second section of track and the third section of track. The testing station further includes a machine-readable instruction set stored in the non-transitory computer readable memory that, when executed, causes the processor to: receive, from a first sensor of the one or more sensors, one or more signals indicating the cart is traversing the third section of track, and in response to receiving the one or more signals indicating that the cart is traversing the third section of track, determine the cart is functioning.

In another embodiment, a system for testing an industrial cart in an assembly line grow pod includes a track comprising a growing section coupled to a testing section, a master controller comprising a processor and a non-transitory computer readable memory communicatively coupled to the processor, one or more electric power sources electrically coupled to the track, and a plurality of carts supported on the track, at least one cart of the plurality of carts comprising: at least two pairs of wheels supported on the track and electrically coupled to the track, and a drive motor coupled to the at least one cart such that an output of the drive motor propels the at least one cart along the track. The system further includes one or more electric power sources provides electric power to at least one pair of the at least two pairs of wheels of the at least one cart such that the electric power powers the drive motor, and a testing station comprising the testing section of the track, where the testing section of the track comprises: a first section of track, a second section of track, and a third section of track. The first section of track mechanically couples to the second section of track, the second section of track mechanically couples to the third section of track, the first section of track is electrically isolated from the second section of track, and the second section of track is electrically isolated from the third section of track. The system further includes one or more sensors communicatively coupled to the master controller, where the one or more sensors are configured to at least detect the at least one cart traversing the third section of track, where: the electric power source electrically couples to the second section of track, the second section of track provides electric power to a first pair of wheels of a first cart when the first cart traverses the first section of track and the second section of track, and the second section of track provides electric power to a second pair of wheels when the first cart traverses the second section of track and the third section of track. The system further includes a machine-readable instruction set stored in the non-transitory computer readable memory that, when executed, causes the processor to: receive, from a first sensor of the one or more sensors, one or more signals indicating the cart is traversing the third section of track, and in response to receiving the one or more signals indicating that the cart is traversing the third section of track, determine the cart is functioning.

In another embodiment, a method of testing a cart with a testing station includes providing electric power to a second section of track, where the second section of track is coupled to a first section of track at one end and a third section of track on an opposite end of the second section of track, detecting, using a first sensor, the cart traversing the first section of track, activating a timer in response to detecting the cart with the first sensor, detecting, using a second sensor, the cart traversing the second section of track, determining an amount of time that lapsed from detecting the cart with the first sensor to detecting the cart with the second sensor, determining whether the amount of time is greater than a predetermined threshold, determining that the cart failed when the amount of time is greater than the predetermined threshold, and determining that the cart passed when the amount of time is not greater than the predetermined threshold.

These and additional features provided by the embodiments described herein will be more fully understood in view of the following detailed description, in conjunction with the drawings.

### BRIEF DESCRIPTION OF THE DRAWINGS

The embodiments set forth in the drawings are illustrative and exemplary in nature and not intended to limit the disclosure. The following detailed description of the illustrative embodiments can be understood when read in conjunction with the following drawings, where like structure is indicated with like reference numerals and in which:

FIG. 1 depicts an illustrative assembly line grow pod that includes a plurality of industrial carts according to embodiments described herein;

FIG. 1B schematically depicts a second view of the assembly line grow pod, according to one or more embodiments shown and described herein;

FIG. 2 depicts an illustrative network environment for various components in an assembly line grow pod according to embodiments described herein;

FIG. 3A schematically depicts a testing station for an industrial cart in an assembly line configuration according to embodiments described herein;

FIG. 3B schematically depicts an example of a cart diverter of a testing station for an industrial cart in an assembly line configuration according to embodiments described herein;

FIG. 4 depicts various components of a cart testing system according to embodiments described herein;

FIG. 5 schematically depicts various components of an illustrative cart-computing device for facilitating communications according to one or more embodiments shown and described herein; and

FIG. 6 depicts a flowchart of an illustrative method of testing an industrial cart in a grow pod assembly according to embodiments described herein.

### DETAILED DESCRIPTION

Embodiments disclosed herein generally include systems and methods for testing the functionality of one or more industrial carts in an assembly line configuration of a grow pod. Some embodiments are configured such that an industrial cart supporting a payload travels on a track of a grow pod to provide sustenance (such as light, water, nutrients, etc.) to seeds and/or plants included in the payload on the industrial cart. The industrial cart (also referred to herein as “cart”) may be among one or more other industrial carts arranged on the track of the grow pod to create an assembly line of industrial carts. In some embodiments, the industrial cart receives power from the track to energize a drive motor which causes the industrial cart to be propelled along the track through the grow pod. When there is a malfunction with the mechanisms for receiving power and/or propelling the industrial cart, other industrial carts may push the failed industrial cart along the track. However, since there may be many carts traveling on the track at any one time, systems and methods are needed to identify when a cart is failed so that it may be removed, replaced, and/or repaired. Embodiments described herein disclose systems and methods for testing the functionality of an industrial cart and in some embodiments, automatically remove the industrial cart for servicing.

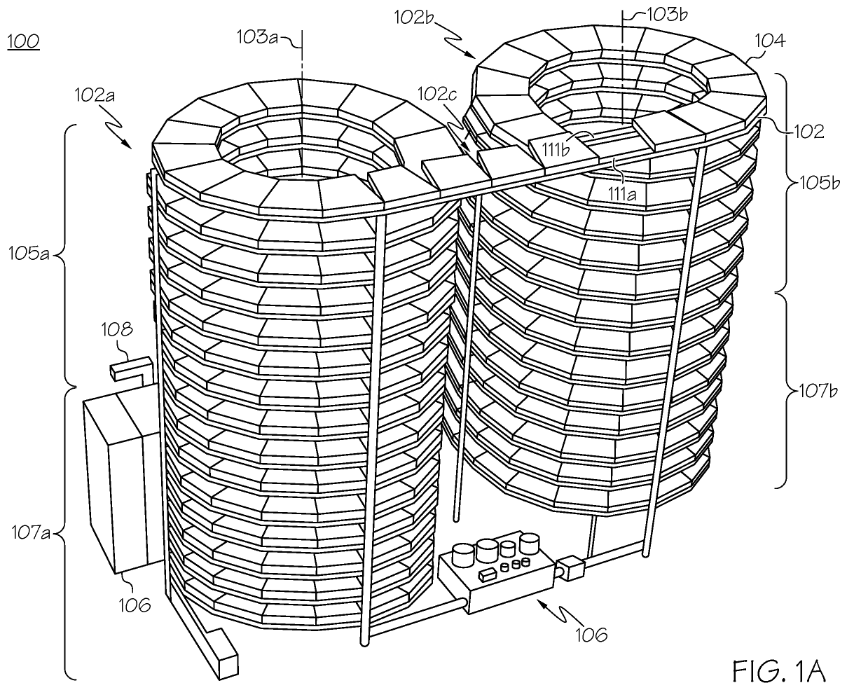

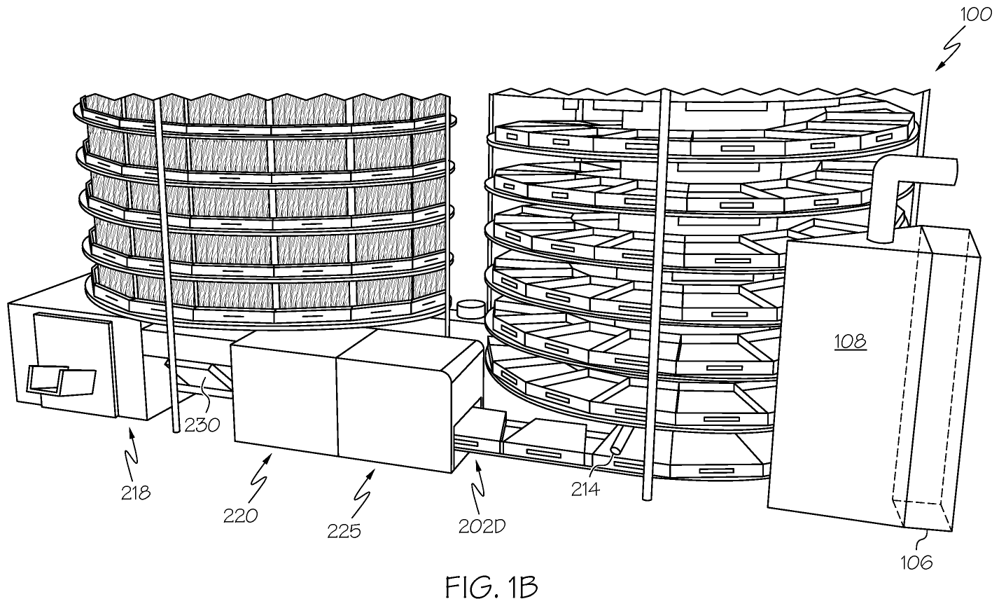

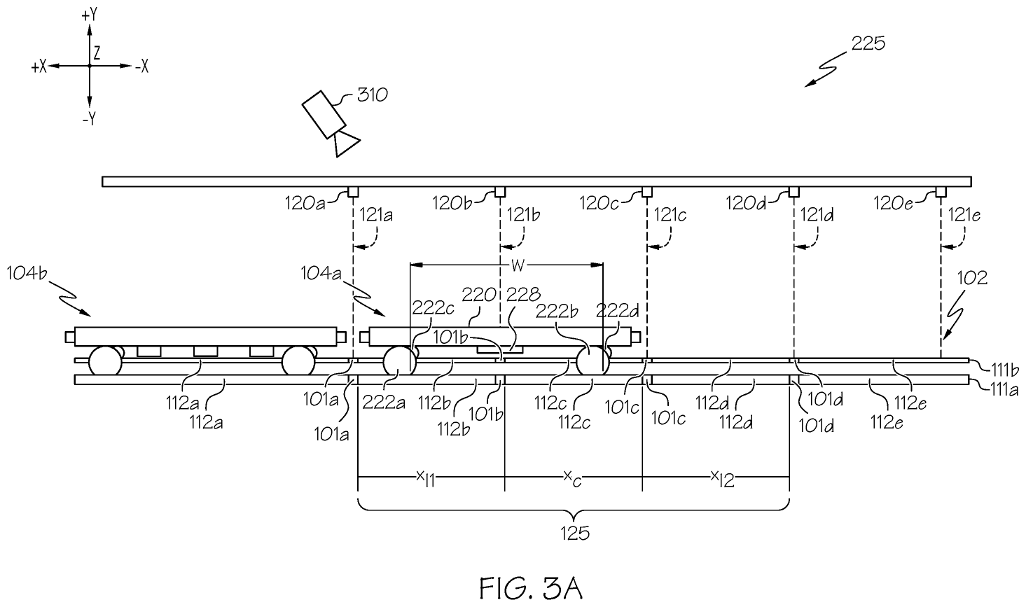

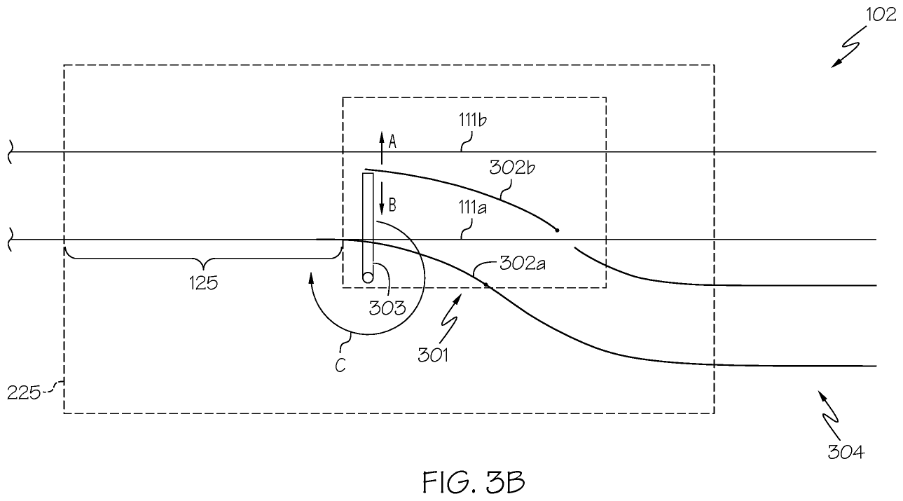

Referring now to the drawings, FIG. 1A depicts an illustrative assembly line grow pod 100 that includes a plurality of industrial carts 104. As illustrated, the assembly line grow pod 100 includes a track 102 that supports one or more industrial carts 104. Each of the one or more industrial carts 104 may include one or more wheels 222a-222d (collectively, referred to as 222, FIG. 3A) rotatably coupled to the industrial cart 104 and supported on the track 102.

The track 102 may include an ascending portion 102a, a descending portion 102b, and a connection portion 102c. The ascending portion 102a may be coupled to the descending portion 102b via the connection portion 102c. The track 102 may wrap around (e.g., in a counterclockwise direction as depicted in FIG. 1A) a first axis 103a such that the industrial carts 104 ascend upward in a vertical direction. The connection portion 102c may be relatively level and straight (although these are not requirements). The connection portion 102c is utilized to transfer the industrial carts 104 from the ascending portion 102a to the descending portion 102b. The descending portion 102b may be wrapped around a second axis 103b (e.g., in a counterclockwise direction as depicted in FIG. 1A) that is substantially parallel to the first axis 103a, such that the industrial carts 104 may be returned closer to ground level. Each of the ascending portion 102a and the descending portion 102b includes an upper portion 105a and 105b, respectively, and a lower portion 107a and 107b, respectively. In some embodiments, a second connection portion 202d (FIG. 1B) may be positioned near ground level that couples the descending portion 102b to the ascending portion 102a such that the industrial carts 104 may be transferred from the descending portion 102b to the ascending portion 102a. Similarly, some embodiments may include more than two connection portions 102c to allow different industrial carts 104 to travel different paths. As an example, some industrial carts 104 may continue traveling up the ascending portion 102a, while some may take one of the connection portions 102c before reaching the top of the assembly line grow pod 100.

Also depicted in FIG. 1A is a master controller 106. The master controller 106 may include an input device, an output device and/or other components. The master controller 106 may be coupled to a nutrient dosing component, a water distribution component, a testing station 225 (FIG. 1B), a seeder component 208 (FIG. 1B), and/or other hardware for controlling various components of the assembly line grow pod 100.

FIG. 1B depicts a second view of the assembly line grow pod 200 illustrating a plurality of components of an assembly line grow pod 200 is depicted. As illustrated, a seeder component 208, lighting devices, a harvester component 218, a sanitizer component 220, and a testing station 225 are illustrated.

The seeder component 208 may be configured to provide seeds to one or more carts 104 as the carts 104 pass the seeder in the assembly line. The watering component may be coupled to one or more water lines 210, which distribute water and/or nutrients to one or more trays 230 (FIG. 1B) at predetermined areas of the assembly line grow pod 100. Also, the master controller 106 may include and/or be coupled to one or more components that delivers airflow for temperature control, pressure, carbon dioxide control, oxygen control, nitrogen control, etc. For example, airflow lines may distribute the airflow at predetermined areas in the assembly line grow pod 100.

The assembly line grow pod 100 may include a plurality of lighting devices such as light emitting diodes (LEDs). The lighting devices may provide light waves that may facilitate plant growth. Additionally, as the plants are provided with light, water, and nutrients, the carts 104 traverse the track 102 of the assembly line grow pod 100. Additionally, the assembly line grow pod 100 may detect a growth and/or fruit output of a plant and may determine when harvesting is warranted. If harvesting is warranted prior to the cart 104 reaching the harvester, modifications to a recipe may be made for that particular cart 104 until the cart 104 reaches the harvester. Conversely, if a cart 104 reaches the harvester component 218 and it has been determined that the plants in that cart 104 are not ready for harvesting, the assembly line grow pod 100 may commission that cart 104 for another cycle. This additional cycle may include a different dosing of light, water, nutrients, and/or other treatment and the speed of the cart 104 could change, based on the development of the plants on the cart 104. If it is determined that the plants on a cart 104 are ready for harvesting, the harvester component 218 may facilitate that process.

Still referring to FIG. 1B, the sanitizer component 220 may clean the cart 104 and/or tray and return the tray 230 to a growing position, which is substantially parallel to ground. Additionally, a seeder head 214 may facilitate seeding of the tray 230 as the cart 104 passes. It should be understood that while the seeder head 214 is depicted in FIG. 1B as an arm that spreads a layer of seed across a width of the tray 230, this is merely an example. Some embodiments may be configured with a seeder head 214 that is capable of placing individual seeds in a desired location.

In some embodiments, a testing station 225 may be configured along the track 102, for example, after the sanitizer component 220. As described in more detail herein, the testing station operates to test the functionality of a cart and determine whether the cart is capable of returning to service or needs to be removed and repaired. While FIG. 1B depicts the testing station 225 after the sanitizer component 220 and before the seeder head 214, this is only an example. The testing station 225 may be positioned at various locations along the track 102 to facilitate testing of the cart. For example, the testing station may be positioned before the harvester component 218 or before the sanitizer component 220. Embodiments described now relate to the testing station and the systems and methods thereof.

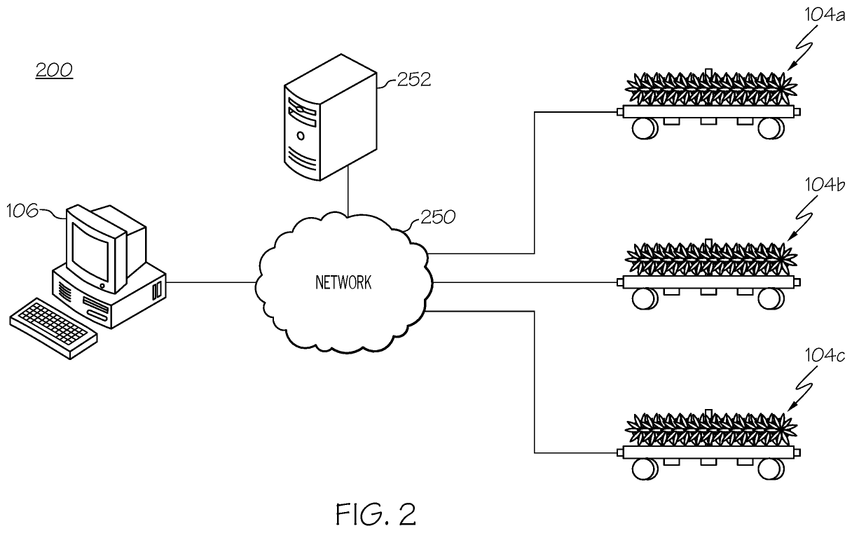

FIG. 2 depicts an illustrative network environment 200 for an industrial cart 104 in a grow pod. As illustrated, each of a plurality of industrial carts 104 (e.g., a first industrial cart 104a, a second industrial cart 104b, and a third industrial cart 104c and collectively referred to herein as industrial cart(s) 104 or cart(s) 104) may be communicatively coupled to a network 250. Additionally, the network 250 may be communicatively coupled to the master controller 106 and/or a remote computing device 252. The master controller 106 may be configured to communicate with and control various components of the assembly line grow pod 100 including the plurality of industrial carts 104.

The master controller 106 may be a personal computer, laptop, mobile device, tablet, server, etc. and may be utilized as an interface to the assembly line grow pod 100 for a user. Depending on the embedment, the master controller 106 may be integrated as part of the assembly line grow pod 100 or may be merely coupled to the assembly line grow pod 100. For example, an industrial cart 104 may send a notification to a user through the master controller 106.

Similarly, the remote computing device 252 may include a server, personal computer, tablet, mobile device, etc. and may be utilized for machine-to-machine communications. As an example, if the cart 104 (and/or assembly line grow pod 100 from FIG. 1) determines that a type of seed being used requires a specific configuration for the assembly line grow pod 100 to increase plant growth or output (e.g., through the cart-computing device 228 and/or one or more sensors), then the cart 104 may communicate with the remote computing device 252 to retrieve the desired data and/or settings for the specific configuration.

The desired data may include a recipe for growing that type of seed and/or other information. The recipe may include time limits for exposure to light, amounts of water and the frequency of watering, environmental conditions such as temperature and humidity, and/or the like. The cart 104 may further query the master controller 106 and/or remote computing device 252 for information such as ambient conditions, firmware updates, etc. Likewise, the master controller 106 and/or the remote computing device 252 may provide one or more instructions in a communication signal to the cart 104 that includes control parameters for the drive motor 226. As such, some embodiments may utilize an application program interface (API) to facilitate this or other computer-to-computer communications.

The network 250 may include the internet or other wide area network, a local network, such as a local area network, a near field network, such as Bluetooth or a near field communication (NFC) network. In some embodiments, the network 250 is a personal area network that utilizes Bluetooth technology to communicatively couple the master controller 106, the remote computing device 252, one or more carts 104, and/or any other network connectable device. In some embodiments, the network 250 may include one or more computer networks (e.g., a personal area network, a local area network, or a wide area network), cellular networks, satellite networks and/or a global positioning system and combinations thereof. Accordingly, at least the one or more carts 104 may be communicatively coupled to the network 250 via the electrically conductive track 102, via wires, via a wide area network, via a local area network, via a personal area network, via a cellular network, via a satellite network, and/or the like. Suitable local area networks may include wired Ethernet and/or wireless technologies such as, for example, Wi-Fi. Suitable personal area networks may include wireless technologies such as, for example, IrDA, Bluetooth, Wireless USB, Z-Wave, ZigBee, and/or other near field communication protocols. Suitable personal area networks may similarly include wired computer buses such as, for example, USB and FireWire. Suitable cellular networks include, but are not limited to, technologies such as LTE, WiMAX, UMTS, CDMA, and GSM.

Communications between the various components of the network environment 200 may be facilitated by various components of the assembly line grow pod 100. For example, the track 102 may include one or more rails that support the cart 104 and are communicatively coupled to the master controller 106 and/or remote computing device 252 through the network 250 as shown in FIGS. 1A and 1B. In some embodiments, the track 102 includes at least two rails 111a and 111b. Each of the two rails 111a and 111b of the track 102 may be electrically conductive. Each rail 111 may be configured for transmitting communication signals and electric power to and from the industrial cart 104 via the one or more wheels 222 (FIG. 3A) rotatably coupled to the industrial cart 104 and supported by the track 102. That is, a portion of the track 102 is electrically conductive and a portion of the one or more wheels 222 is in electrical contact with the portion of the track 102 that is electrically conductive.

Referring to FIG. 3A a testing station 225 for a cart 104a in an assembly line configuration is depicted. The testing station 225 provides various energized and non-energized sections of track to test the electric power pick-up and delivery circuits of the wheels 222 of the cart 104a and the subsequent functionality of the drive motor of the cart 104a. The testing of cart 104a may occur while the other carts 104b remain stopped, that is, one cart, cart 104a, may traverse the test track section 125 at a time. The cart 104a may include at least two pairs of wheels 222, a front pair of wheels 222b and 222d and a rear pair of wheels 222a and 222c. Electronic circuits of the cart 104a are configured source power from either the front pair of wheels 222b and 222d or the rear pair of wheels 222a and 222c that s received from an electric power source via the track 102. The functionality of both the front pair of wheels 222b and 222d and the rear pair of wheels 222a and 222c allows the cart 104a to receive power from the track 102 as the cart 104a traverses from one section of track 102 to another. That is, the growing sections of track 102 of the assembly line grow pod may be electrically isolated into multiple sections in order to provide electric power and communications signals to the plurality of carts 104 of the track 102 at various portions of the track 102 of the assembly line grow pod.

The testing station 225 includes a length of track 102 that may couple in line with the track 102 of the assembly line grow pod 100. The length of track 102 of the testing station includes sections of track that are configured to provide electric power to a cart 104a or not provide electric power to the cart 104a. As depicted, for example, the testing station 225 includes a first section 112b, a second section 112c, and a third section 112d. The first section 112b, the second section 112c, and the third section 112d are mechanically coupled and electrically isolated from each other. That is, the first section 112b is mechanically coupled to the second section 112c and the second section 112c is mechanically coupled to the third section 112c. In some embodiments, the first section 112b, the second section 112c, and the third section 112d are mechanically coupled by isolation sections 101 (e.g., isolation section 101b between the first section 112b and the second section 112c and isolation section 101c between the second section 112c and the third section 112d). The isolation sections may be an electrically insulating material such as plastic or may represent an air gap between the one or more rails of each section of track 102.

Furthermore, the track 102 of the testing station 225 is coupled to the track 102 of the assembly line grow pod 100. A growing section 112a of the track 102 of the assembly line grow pod 100 is mechanically coupled to the first section 112b of track 102 of the testing station 225. The growing section 112a and the first section 112b may be isolated from each other by an isolation section 101a. Additionally, the track 102 of the testing station 225 at the output (i.e., the third section 112d) is mechanically coupled back to the track 102 of the assembly line grow pod 100 (i.e., the third section 112d is coupled to growing section 112e of the assembly line grow pod 100. The growing section 112e and the third section 112d may be isolated from each other by an isolation section 101d.

The first section 112b, second section 112c, and the third section 112d may include conductive or non-conductive rails depending on the testing configuration. By way of example, the first section 112b and the third section 112d may include conductive rails not connected to an electric power source or may include non-conductive material as the rails. However, the second section 112c may then include rails that are conductive and electrically coupled to an electric power source. In other embodiments, the first section 112b and the third section 112d may include conductive rails and may be energized by an electric power source, while the second section 112b includes either non-conductive material as the rails or conductive material that is not energized.

Still referring to FIG. 3A, the testing station may also include one or more sensors 120a, 120b, 120c, 120d, 120E (collectively referred to as the one or more sensors 120). While five sensors are depicted, this is only an example; more or fewer sensors may be implemented. The one or more sensors 120 are positioned to detect the presence of a cart along a predefined portion of the track 102. The one or more sensors 120 may include infrared sensors, laser sensors, proximity sensors, weight sensors, magnetic sensors, or any sensor capable of generating a signal in response to detecting or not detecting the presence of an object. For example, a first sensor 120a may be positioned at the entrance to the testing station 225 where the cart 104 transitions from the growing section 112a to the first section 112b. The first sensor 120a may generate a signal indicating a cart 104 is entering the testing station 225. For example, this may be accomplished by the cart 104a interrupting an infrared beam 121a emitted by the first sensor 120a.

Additionally, a second sensor 120b, a third sensor 120c, and a fourth sensor 120d may be positioned periodically along the test track section 125 which includes the first section 112b, the second section 112c, and the third section 112d of track 102. For example, the second sensor 120b, the third sensor 120c, and the fourth sensor 120d may generate a beam 121b, 121c, 121d, respectively, which when interrupted by the cart 104a causes the sensor to generate a signal indicating a location of the cart 104 adjacent the sensor.

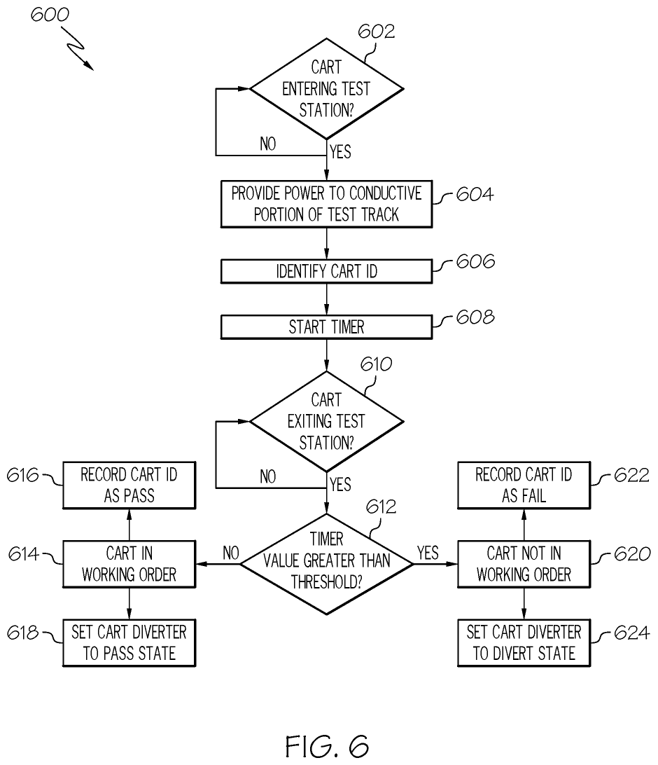

As described in more detail with respect to the flowchart of an example method for testing the functionality of the cart in FIG. 6, signals from the one or more sensors may activate or deactivate a timer for determining how long a cart 104a takes to traverse the testing station 225.

Additionally, the testing station 225 may include a bar code or QR scanner, or an imaging device such as a camera for identifying a unique identifier of a cart 104a in the testing station. The unique identifier may be a serial number, a bar code, a QR code, radio frequency identifier, or the like. The unique identifier may be utilized to set that status of the cart 104a with the master controller 106. For example, if the testing station 225 determines that a cart fails the functionality test, then the status associated with the identified unique identifier of the cart 104 may be updated and/or recorded with the master controller 106. In some embodiments, the camera may be utilized to determine the presence of a cart 104a in the testing station.

The unique identifier may further be utilized to log test history for a particular cart. When a unique identifier of a cart is identified and transmitted to the master controller, the master controller may access or create a log for that cart. The log may include a history of testing and diagnostics results for the particular cart 104. The master controller may also provide the testing station with a notification that the cart should be removed from service for routine maintenance or replacement of a component based on the cart's logged service hours. Conversely, the testing station 225 through the one or more sensors and connected controller may provide the master controller with detailed test results relating to the functionality of the cart. These results may indicate that a component is nearing the of its service life and need to be replaced soon. Therefore, the master controller may determine whether a replacement component is in inventory or whether a part needs to be ordered. As such, the replacement part may be procured in advance of a failure and the cart may be timely serviced, for example during its next visit to the testing station. The master controller may also predict when there might be a failure to a component or to the functionality of the cart based on the logged test data and/or the hours of service.

The testing station 225 is generally configured to test whether both pairs of wheels of the cart 104a are functioning. This is accomplished by traversing the cart over a test track section 125 having alternating sections that are energized and not energized so that for at least two intervals they cart 104 may only receive power through the front pair of wheels 222b and 222d or the rear pair of wheels 222a and 222c. For example, when a cart 104a enters the testing station 225, the front pair of wheels 222b and 222d may contact the first section 112b which may not be energized. Therefore, only the rear pair of wheels 222a and 222c may be receiving electric power from the growing section of track 112a. As the cart 104 is propelled by the drive motor which receives electric power from the growing section of track 112a via the rear pair of wheels 222a and 222c, the front pair of wheels 222b and 222d transition from the first section 112b to the second section 112c and the rear pair of wheels 222a and 222c transition from the growing section of track 112a to the first section 112b. In this example, the first section 112b and the third section 112c do not provide electric power and the second section 112c is energized and coupled to an electric power source.

Continuing with the above example, as the front pair of wheels 222b and 222d receive electric power from the second section 112c; the cart is propelled along the test track section 125. In some instances, the front pair of wheels 222b and 222d and the rear pair of wheels 222a and 222c may both engage the second section 112c. As the cart 104a continues to be propelled, the front pair of wheels 222b and 222d transition from the second section 112c to the third section 112d and the rear pair or wheels 222a and 222c is the sole pair of wheels engaged with an energized section, the second section 112c. If the cart 104 is fully functional, the rear pair or wheels 222a and 222c will continue to receive electric power from the track causing the cart to be propelled. If the rear pair or wheels 222a and 222c or the electric circuit corresponding to receiving electric power from the track and delivering the electric power to the drive motor are not functioning correctly the cart will not continue move along the test track section 125. In some embodiments, a cart 104a may be pushed into the testing station by a trialing cart 104b because the cart 104a is not operating. In such a case, the cart 104a may remain parked within the testing station 225 until the next testing cycle where the trailing cart 104b enters and pushes the cart 104a through. In other embodiments, a mechanism such as a robotic arm pushes the non-functioning cart 104a clear of the testing station 225. For example, an arm may be configured to traverse the testing station after each testing cycle to move a failed cart from the testing station before the next testing cycle begins.

In some embodiments, the length of each section of track is configured such that each pair of wheels 222 of the cart 104a may be tested in isolation. In the test track section configuration depicted in FIG. 3A, the following relationships between the length of track of each section and the wheelbase of the cart enable each pair of wheels 222 of the cart 104a to be tested in isolation. The length X_{I1} of the first section 112b is less than the wheelbase W of the cart 104a. The length X_{I2} of the third section 112d is less than the wheelbase W of the cart 104a. The length X_{C} of the second section 112c, the energized section, is greater than or equal to the wheelbase W of the cart 104a. The length X_{I1} of the first section 112b plus the length X_{C} of the second section 112c is greater than or equal to the wheelbase W of the cart 104a. The length X_{I2} of the third section 112d plus the length X_{C} of the second section 112c is greater than or equal to the wheelbase W of the cart 104a. The length X_{I1} of the first section 112b plus the length X_{C} of the second section 112c plus the length X_{I2} of the third section 112d is less than two (2) times the wheelbase W of the cart 104a. It should be understood that these are only example relationships of track length and wheelbase for the example test track configuration depicted in FIG. 3A. It should further be understood that other test track configurations may be possible and achieve the same result of independently testing each pair of wheels 222 of the cart 104a.

Referring now to FIG. 3B, an extension of the testing station 225 is depicted. In particular, an example of a cart diverter of a testing station for an industrial cart in an assembly line configuration is depicted. The cart diverter 301 is one example for removing a cart 104 that has failed to traverse the test track section 125 of the testing station 225. As depicted the output of the test track section 125 may be coupled to a cart diverter 301 which includes a switch section having rails 302a and 302b which can be selectively configured into a first position (A) or a second position (B). When configured in the first position (A) a failed cart may traverse rails 302a and 302b to diversion section of track 304. When configured in the second position (B) a functioning cart may traverse rails 111a and 111b to the growing section of the track 102 of the assembly line grow pod for further use.

In some embodiments, the testing station may include a robotic arm 303 that is capable of moving a cart along the track 102. For example, when cart 104 is determined to have failed the functionality test, a robotic arm may traverse laterally along the test track section or sweep in a rotation (C) about a pivot point thereby advancing the failed cart 104 from the test track section 125 and optionally to the diversion section of track 304.

The cart diverter 301 may be electronically and selectively configured with electro-mechanical components such as actuators, gears, motors or the like so that the master controller or another computing device may activate and set the position of the switch section in either the first position (A) or the second position (B).

In some embodiments, the testing station 225 may also be configured to test other functions and components of the cart 104. For example, the testing station may determine whether the wheels of the cart 104 are rotating or locked up and being dragged along the track 102. The testing station 225 may utilize a camera directed at the wheel of the cart to monitor the wheel spin and turn as the cart traverses the testing station. In some embodiments, a section of track may include a set of friction wheels coupled to a motor causing the friction wheels to rotate. That is, when a wheel of the cart engages the friction wheels as the cart traverses the testing station 225, the friction wheels rotate the wheels of the cart in place and may utilize one or more sensors to determine the resistance in rotation of the wheels of the cart. The presence of friction above a predetermined threshold may indicate that the wheel of the cart may need to be replaced.

In some embodiments, the testing station may include probes or other sensors for engaging with components of the cart such as a proximity sensor on the cart. For example, a proximity sensor of the cart may cause the cart to stop if an object is detected in its path. As such, the testing station may simulate the presence of an object and determine whether the cart stopped moving. The testing station 225 may also include mechanisms for rotating a tray on the cart while monitoring the movement of the tray with a camera or other sensor to determine whether the tray properly rotates about its hinge and then returns to the cart in an operational position. For example, a camera may detect a tray rotation failure if the tray fails to rotate a predetermined number of degrees or becomes disconnected from the cart when it is supposed to be rotating about a hinge.

It is further possible that the testing station 225 is configured to test communication functions of a cart. For example, a cart may be configured to receive operational commands via the wheels of the cart. As such, the testing station 225 may include a controller capable of generating and transmitting simulated operational commands to the cart in the testing station. For example, the controller may send a command for the cart to stop, move forward, stop, move in reverse, stop and then again advance forward. A camera or other sensors such as infrared sensors positions along the track may monitor the cooperation of the cart and determine whether each of the simulated operational commands were carried out by the cart.

The testing station may also test wireless communications of the cart. For example, the testing station may include a transceiver that send simulated commands to the cart and if the wireless communications of the cart are operational, the transceiver may receive one or more confirmation messages from the cart.

In response to the tests performed on the cart in the testing station, the master controller or another controller may make a determination as to whether the malfunctioning component or functionality failure requires a replace component or may be repaired. For example, if a cart fails to traverse the testing station, a further test may be initiated such as a continuity test between the wheel and the cart electronics. Such a test may indicate that there is a bad connection (e.g., a high resistance path) which is causing the malfunction and not a component failure which may require a replacement part. That is, a wire may need to be reattached or a solder joint repaired, but a wheel or drive motor may still be fully functional.

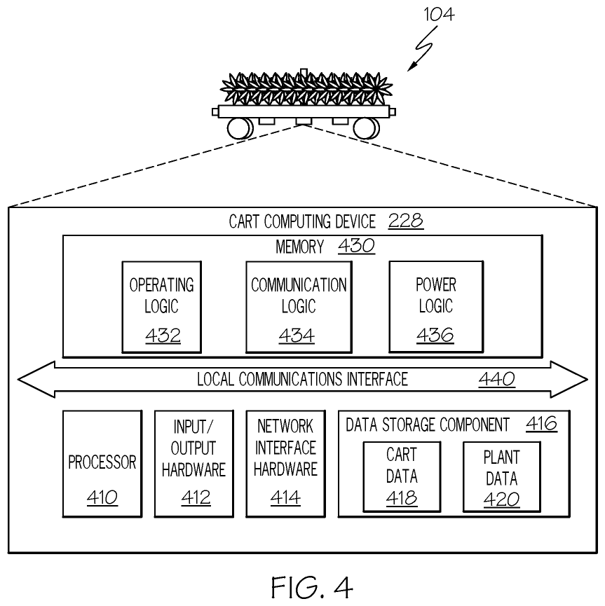

FIG. 4 depicts an illustrative cart-computing device 228 for facilitating communication. As illustrated, the cart-computing device 228 includes a processor 410, input/output hardware 412, the network interface hardware 414, a data storage component 416 (which stores systems data 418, plant data 420, and/or other data), and the memory component 430. The memory component 430 may store operating logic 432, the communications logic 434, and the power logic 436. The communications logic 434 and the power logic 436 may each include a plurality of different pieces of logic, each of which may be embodied as a computer program, firmware, and/or hardware, as an example. A local communications interface 440 is also included in FIG. 4 and may be implemented as a bus or other communication interface to facilitate communication among the components of the cart-computing device 228.

The processor 410 may include any processing component operable to receive and execute instructions (such as from a data storage component 416 and/or the memory component 430). The processor 410 may be any device capable of executing the machine-readable instruction set stored in the memory component 430. Accordingly, the processor 410 may be an electric controller, an integrated circuit, a microchip, a computer, or any other computing device. The processor 410 is communicatively coupled to the other components of the assembly line grow pod 100 by a communication path and/or the local communications interface 440. Accordingly, the communication path and/or the local communications interface 440 may communicatively couple any number of processors 410 with one another, and allow the components coupled to the communication path and/or the local communications interface 440 to operate in a distributed computing environment. Specifically, each of the components may operate as a node that may send and/or receive data. While the embodiment depicted in FIG. 4 includes a single processor 410, other embodiments may include more than one processor 410.

The input/output hardware 412 may include and/or be configured to interface with microphones, speakers, a keyboard, a display, and/or other hardware. For example, the display may provide text and/or graphics indicating the status of each industrial cart 104 in the assembly line grow pod 100.

The network interface hardware 414 is coupled to the local communications interface 440 and communicatively coupled to the processor 410, the memory component 430, the input/output hardware 412, and/or the data storage component 416. The network interface hardware 414 may be any device capable of transmitting and/or receiving data via a network 250 (FIG. 2). Accordingly, the network interface hardware 414 can include a communication transceiver for sending and/or receiving any wired or wireless communication. For example, the network interface hardware 414 may include and/or be configured for communicating with any wired or wireless networking hardware, including an antenna, a modem, LAN port, Wi-Fi card, WiMax card, ZigBee card, Bluetooth chip, USB card, mobile communications hardware, near-field communication hardware, satellite communication hardware and/or any wired or wireless hardware for communicating with other networks and/or devices.

In one embodiment, the network interface hardware 414 includes hardware configured to operate in accordance with the Bluetooth wireless communication protocol. In another embodiment, the network interface hardware 414 may include a Bluetooth send/receive module for sending and receiving Bluetooth communications to/from the network 250 (FIG. 2). The network interface hardware 414 may also include a radio frequency identification (“RFID”) reader configured to interrogate and read RFID tags. From this connection, communication may be facilitated between the cart-computing devices 228 of the industrial carts 104, the master controller 106 and/or the remote computing device 252 depicted in FIG. 2.

The memory component 430 may be configured as volatile and/or nonvolatile memory and may comprise RAM (e.g., including SRAM, DRAM, and/or other types of RAM), ROM, flash memories, hard drives, secure digital (SD) memory, registers, compact discs (CD), digital versatile discs (DVD), or any non-transitory memory device capable of storing machine-readable instructions such that the machine-readable instructions can be accessed and executed by the processor 410. Depending on the particular embodiment, these non-transitory computer-readable mediums may reside within the cart-computing device 228 and/or external to the cart-computing device 228. The machine-readable instruction set may comprise logic or algorithm(s) written in any programming language of any generation (e.g., 1GL, 2GL, 3GL, 4GL, or 5GL) such as, for example, machine language that may be directly executed by the processor 410, or assembly language, object-oriented programming (OOP), scripting languages, microcode, etc., that may be compiled or assembled into machine readable instructions and stored in the non-transitory computer readable memory, e.g., the memory component 430. Alternatively, the machine-readable instruction set may be written in a hardware description language (HDL), such as logic implemented via either a field-programmable gate array (FPGA) configuration or an application-specific integrated circuit (ASIC), or their equivalents. Accordingly, the functionality described herein may be implemented in any conventional computer programming language, as pre-programmed hardware elements, or as a combination of hardware and software components. While the embodiment depicted in FIG. 4 includes a single non-transitory computer readable memory, e.g. memory component 430, other embodiments may include more than one memory module.

Still referring to FIG. 4, the operating logic 432 may include an operating system and/or other software for managing components of the cart-computing device 228. As also discussed above, the communications logic 434 and the power logic 436 may reside in the memory component 430 and may be configured to perform the functionality, as described herein.

It should be understood that while the components in FIG. 4 are illustrated as residing within the cart-computing device 228, this is merely an example. In some embodiments, one or more of the components may reside on the industrial cart 104 external to the cart-computing device 228. It should also be understood that, while the cart-computing device 228 is illustrated as a single device, this is also merely an example. In some embodiments, the communications logic 434 and the power logic 436 may reside on different computing devices. As an example, one or more of the functionalities and/or components described herein may be provided by the master controller 106 and/or the remote computing device 252.

Additionally, while the cart-computing device 228 is illustrated with the communications logic 434 and the power logic 436 as separate logical components, this is also an example. In some embodiments, a single piece of logic (and/or or several linked modules) may cause the cart-computing device 228 to provide the described functionality.

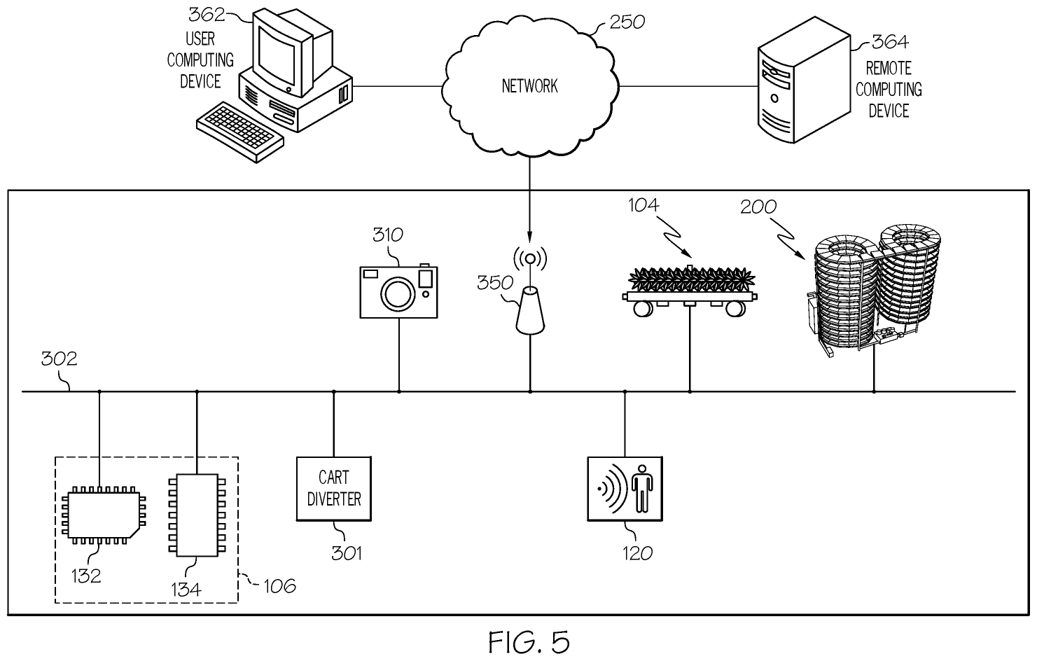

Referring now to FIG. 5, a schematic of various components of a cart testing system is depicted. The cart testing system may have a plurality of components including the master controller 106 having a processor 132 communicatively coupled to non-transitory computer-readable memory 134, the cart diverter 301, a camera 310, a communication module 350, one or more sensors 120, one or more carts 104, and other components of the assembly line grow pod 100. The plurality of components of the cart testing system may be physically coupled and/or may be communicatively coupled through a communication path 302 and/or network 250. The various components of the cart testing system and the interaction thereof will be described in detail herein.

The communication path 302 may be formed from any medium that is capable of transmitting a signal such as, for example, conductive wires, conductive traces, optical waveguides, or the like. The communication path 302 may also refer to the expanse in which electromagnetic radiation and their corresponding electromagnetic waves traverse. Moreover, the communication path 302 may be formed from a combination of mediums capable of transmitting signals. In one embodiment, the communication path 302 comprises a combination of conductive traces, conductive wires, connectors, and buses that cooperate to permit the transmission of electrical data signals to components such as processors, memories, sensors, input devices, output devices, and communication devices. Accordingly, the communication path 302 may comprise a bus. Additionally, it is noted that the term “signal” means a waveform (e.g., electrical, optical, magnetic, mechanical or electromagnetic) such as DC, AC, sinusoidal-wave, triangular-wave, square-wave, vibration, and the like, capable of traveling through a medium. The communication path 302 communicatively couples the various components of the cart testing system. As used herein, the term “communicatively coupled” means that coupled components are capable of exchanging signals with one another such as, for example, electrical signals via conductive medium, electromagnetic signals via air, optical signals via optical waveguides, and the like.

Still referring to FIG. 4, the master controller 106 may include any device or combination of components comprising a processor 132 and a non-transitory computer-readable memory 134. The processor 132 of the cart testing system may be any device capable of executing the machine-readable instruction set stored in the non-transitory computer-readable memory 134. Accordingly, the processor 132 may be an electric controller, an integrated circuit, a microchip, a computer, or any other computing device. The processor 132 may be communicatively coupled to the other components of the cart testing system by the communication path 302. Accordingly, the communication path 302 may communicatively couple any number of processors with one another, and allow the components coupled to the communication path 302 to operate in a distributed computing environment. Specifically, each of the components may operate as a node that may send and/or receive data. While the embodiment depicted in FIG. 4 includes a single processor, other embodiments may include more than one processor.

The non-transitory computer-readable memory 134 of the cart testing system is coupled to the communication path 302 and communicatively coupled to the processor 132. The non-transitory computer-readable memory 134 may comprise RAM, ROM, flash memories, hard drives, or any non-transitory memory device capable of storing a machine-readable instruction set such that the machine-readable instruction set can be accessed and executed by the processor 132. The machine-readable instruction set (e.g., first logic and/or one or more programming instructions) may comprise logic or algorithm(s) written in any programming language of any generation (e.g., 1GL, 2GL, 3GL, 4GL, or 5GL) such as, for example, machine language that may be directly executed by the processor 132, or assembly language, object-oriented programming (OOP), scripting languages, microcode, etc., that may be compiled or assembled into machine readable instructions and stored in the non-transitory computer-readable memory 134. Alternatively, the machine-readable instruction set may be written in a hardware description language (HDL) such as logic implemented via either a field-programmable gate array (FPGA) configuration or an application-specific integrated circuit (ASIC), or their equivalents. Accordingly, the functionality described herein may be implemented in any conventional computer programming language, as pre-programmed hardware elements, or as a combination of hardware and software components. While the embodiment depicted in FIG. 4 includes a single non-transitory computer-readable memory, other embodiments may include more than one memory module.

The camera 310 may be communicatively coupled to the communication path 302 and to the master controller 106 and/or the cart-computing device 228. The camera 310 may be any device having an array of sensing devices (e.g., pixels) capable of detecting radiation in an ultraviolet wavelength band, a visible light wavelength band, or an infrared wavelength band. The camera 310 may have any resolution. The camera 310 may be an omni-directional camera, or a panoramic camera. In some embodiments, one or more optical components such as a mirror, fish-eye lens, or any other type of lens may be optically coupled to each of the camera 310. In operation, the camera 310 captures images of a cart 104 entering, in or exiting the testing station 225 to determine the unique identifier of the cart 104.

The cart testing system may further be communicatively coupled to the cart diverter 301 as described with respect to FIG. 3B. Additionally, the cart testing system communicatively couples the one or more sensors as described above with respect to FIG. 3A, to the master controller 106 and other components of the cart testing system.

Still referring to FIG. 4, the notification system 300 may include a communication module 350 that couples to the communication path 302 and communicatively couples to the master controller 106. The communication module 350 may be any device capable of transmitting and/or receiving data via a network 250. Accordingly, communication module 350 can include a communication transceiver for sending and/or receiving any wired or wireless communication. For example, the communication module 350 may include an antenna, a modem, LAN port, Wi-Fi card, WiMax card, mobile communications hardware, near-field communication hardware, satellite communication hardware and/or any wired or wireless hardware for communicating with other networks and/or devices. In one embodiment, communication module 350 includes hardware configured to operate in accordance with the Bluetooth wireless communication protocol. In another embodiment, communication module 350 may include a Bluetooth send/receive module for sending and receiving Bluetooth communications to/from a network 250.

In some embodiments, the cart testing system may be communicatively coupled to a user computing device 362 (e.g., a local device) and/or a remote computing device 364 via the network 250. In some embodiments, the network 250 is a personal area network that utilizes Bluetooth technology to communicatively couple the cart testing system to the user computing device 362 and/or a remote computing device 364. In other embodiments, the network 250 may include one or more computer networks (e.g., a personal area network, a local area network, or a wide area network), cellular networks, satellite networks and/or a global positioning system and combinations thereof. Accordingly, cart testing system can be communicatively coupled to the network 250 via wires, via a wide area network, via a local area network, via a personal area network, via a cellular network, via a satellite network, or the like. Suitable local area networks may include wired Ethernet and/or wireless technologies such as, for example, Wi-Fi. Suitable personal area networks may include wireless technologies such as, for example, IrDA, Bluetooth, Wireless USB, Z-Wave, ZigBee, and/or other near field communication protocols. Suitable personal area networks may similarly include wired computer buses such as, for example, USB and FireWire. Suitable cellular networks include, but are not limited to, technologies such as LTE, WiMAX, UMTS, CDMA, and GSM.

Still referring to FIG. 4, as stated above, the network 250 may be utilized to communicatively couple the cart testing system with a user computing device 362 (e.g., a local device) and/or a remote computing device 364. In some embodiments, the network 250 may communicatively couple the cart testing system to the internet. That is, the cart testing system may connect with remote computing devices 364 including but not limited to laptop computers, smart phones, tablet computers, servers, or other networks anywhere in the world.

Referring now to FIG. 6, a flowchart 600 of an illustrative method of testing an industrial cart in a grow pod assembly is depicted. The master controller 106, another computing device such as a user computing device 362 or a remote computing device 364 or a combination of computing devices and components may implement methods of testing an industrial cart in a grow pod assembly. For simplicity, computing device will be used to refer to the aforementioned means of implementation. A computing device may receive one or more signals from one or more sensors. At block 602, the computing device determines from the one or more signals form the one or more sensors whether a cart is entering the test station. If a cart is determined to be entering the testing station, then electric power may be provided to a portion of the test track section at block 604. At block 606, the computing device may receive images or other signals from a camera, a barcode reader or the like identifying a unique identifier for the cart in the testing station. At block 608, in response to a cart entering the testing station, a timer is activated. The computing device continues to monitor the signals from the one or more sensors and when a signal indicating a cart is exiting the test station is determined from the one or more sensors, at block 610, and then the computing device determines the amount of time that has elapsed since the cart entered the test station. At block 612, if the elapsed time is greater than a predetermined threshold, then the computing device advances to block 620. However, if the elapsed time is not greater than a predetermined threshold, then the computing device advances to block 614.

Monitoring the amount of elapsed time is one way of determining whether the cart was able to successfully traverse the test track section. For example, the assembly line grow pod may include a plurality of carts and when a cart fails within the growing sections of the track, other carts may push the cart along so the system does not stop advancing the carts through the growing process. However, when a cart enters the testing station, the system is configured to provide spacing between the carts so that one cart is tested while the other carts receive a stop command and complete their current stage of growing. More particularly, carts with the assembly line grow pod move in unison during a first period of time, T_{go}, and then are stationary for a second period of time, Tₛₜₒₚ. Carts within the testing station do not adhere to these movement commands, rather they are configured to advance through the testing station while the other carts are stationary during the second period of time, Tₛₜₒₚ. As such, by setting the predetermined threshold to a value not longer than the second period of time, Tₛₜₒₚ, if the cart does not traverse the testing station within that time, it can be assumed that the cart was pushed through by another functioning cart entering the testing station indicating that the cart failed the functionality test.

Likewise, if a cart advances through the testing station before a minimum threshold of time it may also be determined that more than one cart advanced through the testing station or there is a malfunction with the propulsion setting of the cart.

At block 614, when a cart is determined to be in working order the computing device may take additional actions. At block 616, the computing device may record a status of pass associated with the unique identifier of the cart. At block 618, the computing device may set the cart diverter, if one is presented, to a pass state so that the cart is not diverted from reentering use in the assembly line grow pod.

At block 620, when a cart is determined not to be in working order the computing device may take additional actions. At block 622, the computing device may record a status of fail associated with the unique identifier of the cart. At block 624, the computing device may set the cart diverter, if one is presented, to a divert state so that the cart is diverted or removed from reentering use in the assembly line grow pod. The computing device may also record in a log other details related to tests performed on the cart during its visit at the testing station. In some instances, the number of service hours may be updated and/or the functionality of a communication system or other sensor components of the cart may be recorded in a log associated with the cart, for example, through a unique identifier assigned to the cart.

It should be understood that the above described method is only one example of a method for testing the functionality of a cart. Other examples may include utilizing different sensors, different test track configurations, or implementing additional features such as a robotic arm for clearing a failed cart from the testing station.

Accordingly, embodiments described herein include systems and/or methods for testing the functionality of an industrial cart for a grow pod. In general, the systems and methods utilize test track configurations designed to test the functionality of isolated components, such as the ability for a single pair of wheels of the cart to receiving electric power from the track and deliver it to the components of the cart.

While particular embodiments and aspects of the present disclosure have been illustrated and described herein, various other changes and modifications can be made without departing from the spirit and scope of the disclosure. Moreover, although various aspects have been described herein, such aspects need not be utilized in combination. Accordingly, it is therefore intended that the appended claims cover all such changes and modifications that are within the scope of the embodiments shown and described herein.

It should now be understood that embodiments disclosed herein include systems, methods, and non-transitory computer-readable mediums for communicating with an industrial cart. It should also be understood that these embodiments are merely exemplary and are not intended to limit the scope of this disclosure.

What is claimed is:

1. A testing station for testing an industrial cart comprising:
a master controller comprising a processor and a non-transitory computer readable memory communicatively coupled to the processor;
a length of track comprising:
a first section of track;
a second section of track; and
a third section of track, wherein:
the first section of track mechanically couples to the second section of track,
the second section of track mechanically couples to the third section of track,
the first section of track is electrically isolated from the second section of track, and
the second section of track is electrically isolated from the third section of track;
one or more sensors communicatively coupled to the master controller, wherein the one or more sensors are configured to at least detect a cart traversing the third section of track;
an electric power source electrically coupled to the second section of track, wherein:
the second section of track provides electric power to a first pair of wheels of a cart when the cart traverses the first section of track and the second section of track, and
the second section of track provides electric power to a second pair of wheels when the cart traverses the second section of track and the third section of track; and
a machine-readable instruction set stored in the non-transitory computer readable memory that, when executed, causes the processor to:
receive, from a first sensor of the one or more sensors, one or more signals indicating the cart is traversing the third section of track; and
in response to receiving the one or more signals indicating that the cart is traversing the third section of track, determine the cart is functioning.

2. The testing station of claim 1, wherein the first section of track and the third section of track are configured to not provide electric power to the cart.

3. The testing station of claim 1, further comprising one or more sensors configured to detect a location of the cart in the testing station.

4. The testing station of claim 3, wherein a first sensor of the one or more sensors is positioned to detect when the cart traverses the first section of track and a second sensor of the one or more sensors is positioned to detect when the cart traverses the third section of track.

5. The testing station of claim 1, wherein the machine-readable instruction set stored in the non-transitory computer readable memory further causes the processor to:
detect, using a second sensor of the one or more sensors, the cart traversing the first section of track;
activate a timer in response to detecting the cart with the first sensor;
determine, based on the timer, an amount of time that lapsed from detecting the cart with the first sensor to detecting the cart with the second sensor;
determine whether the amount of time is greater than a predetermined threshold;
determine that the cart failed when the amount of time is greater than the predetermined threshold; and
determine that the cart passed when the amount of time is not greater than the predetermined threshold.

6. The testing station of claim 5, further comprising a third sensor configured to identify a unique identifier of the cart, wherein the machine-readable instruction set further causes the processor to:
identify, using the third sensor, the unique identifier of the cart; and
record, in the non-transitory computer readable memory, a status of failed and the unique identifier of the cart in response to determining that the amount of time is greater than the predetermined threshold.

7. The testing station of claim 5, further comprising a cart diverter coupled to the third section of track and the cart diverter comprises a switch section of track selectively configurable in a first position or a second position, wherein:
the master controller configures the switch section of track to the first position when the amount of time is not greater than the predetermined threshold, and
the master controller configures the switch section of track to the first position when the amount of time is greater than the predetermined threshold.

8. The testing station of claim 1, wherein the first section of track has a length less than a wheelbase of the cart and the second section of track has a length greater than or equal to the wheelbase of the cart.

9. The testing station of claim 8, wherein the third section of track has a length less than the wheelbase of the cart.

10. A system for testing an industrial cart in an assembly line grow pod comprising:
a track comprising a growing section coupled to a testing section;
a master controller comprising a processor and a non-transitory computer readable memory communicatively coupled to the processor;
one or more electric power sources electrically coupled to the track; and
a plurality of carts supported on the track, at least one cart of the plurality of carts comprising:
at least two pairs of wheels supported on the track and electrically coupled to the track; and
a drive motor coupled to the at least one cart such that an output of the drive motor propels the at least one cart along the track, wherein:
one or more electric power sources provides electric power to at least one pair of the at least two pairs of wheels of the at least one cart such that the electric power powers the drive motor; and
a testing station comprising the testing section of the track, wherein the testing section of the track comprises:
a first section of track;
a second section of track; and
a third section of track, wherein:
the first section of track mechanically couples to the second section of track,
the second section of track mechanically couples to the third section of track,
the first section of track is electrically isolated from the second section of track, and
the second section of track is electrically isolated from the third section of track;
one or more sensors communicatively coupled to the master controller, wherein the one or more sensors are configured to at least detect the at least one cart traversing the third section of track; wherein:
the electric power source electrically couples to the second section of track;
the second section of track provides electric power to a first pair of wheels of a first cart when the first cart traverses the first section of track and the second section of track, and the second section of track provides electric power to a second pair of wheels when the first cart traverses the second section of track and the third section of track; and
a machine-readable instruction set stored in the non-transitory computer readable memory that, when executed, causes the processor to:
receive, from a first sensor of the one or more sensors, one or more signals indicating the cart is traversing the third section of track; and
in response to receiving the one or more signals indicating that the cart is traversing the third section of track, determine the cart is functioning.

11. The system of claim 10, wherein the first section of track and the third section of track are configured to not provide electric power to the first cart.

12. The system of claim 10, further comprising one or more sensors configured to detect a location of the first cart in the testing station.

13. The system of claim 12, wherein a first sensor of the one or more sensors is positioned to detect when the first cart traverses the first section of track and a second sensor of the one or more sensors is positioned to detect when the first cart traverses the third section of track.

14. The system of claim 10, wherein the machine-readable instruction set stored in the non-transitory computer readable memory further causes the processor to:
detect, using a second sensor of the one or more sensors, the cart traversing the first section of track;
activate a timer in response to detecting the cart with the first sensor;
determine, based on the timer, an amount of time that lapsed from detecting the cart with the first sensor to detecting the cart with the second sensor;
determine whether the amount of time is greater than a predetermined threshold;
determine that the cart failed when the amount of time is greater than the predetermined threshold; and
determine that the cart passed when the amount of time is not greater than the predetermined threshold.

15. The system of claim 14, further comprising a third sensor configured to identify a unique identifier of the first cart, wherein the machine-readable instruction set further causes the processor to:
identify, using the third sensor, the unique identifier of the first cart; and
record, in the non-transitory computer readable memory, a status of failed and the unique identifier of the first cart in response to determining that the amount of time is greater than the predetermined threshold.

16. The system of claim 14, further comprising a cart diverter coupled to the third section of track and the cart diverter comprises a switch section of track selectively configurable in a first position or a second position, wherein:
the master controller configures the switch section of track to the first position when the amount of time is not greater than the predetermined threshold, and
the master controller configures the switch section of track to the first position when the amount of time is greater than the predetermined threshold.

17. The system of claim 10, wherein the first section of track has a length less than a wheelbase of the first cart and the second section of track has a length greater than or equal to the wheelbase of the first cart.

18. The system of claim 17, wherein the third section of track has a length less than the wheelbase of the first cart.

19. A method of testing a cart with a testing station, the method comprising:
providing electric power to a second section of track, wherein the second section of track is coupled to a first section of track at one end and a third section of track on an opposite end of the second section of track;
detecting, using a first sensor, the cart traversing the first section of track;
activating a timer in response to detecting the cart with the first sensor;
detecting, using a second sensor, the cart traversing the second section of track;
determining an amount of time that lapsed from detecting the cart with the first sensor to detecting the cart with the second sensor;
determining whether the amount of time is greater than a predetermined threshold;
determining that the cart failed when the amount of time is greater than the predetermined threshold; and
determining that the cart passed when the amount of time is not greater than the predetermined threshold.

20. The method of claim 19, further comprising:
identifying, using a third sensor, a unique identifier of a first cart; and
recording, in a non-transitory computer readable memory, a status of failed and the unique identifier of the first cart in response to determining that the amount of time is greater than the predetermined threshold.
